(19) United States
(12) Patent Application Publication
(10) Pub. No.: US 2005/0250494 A1
(43) Pub. Date: Nov. 10, 2005

(54) Method of assigning unique network code to devices in a home network and a home network system therefor

(75) Inventors: Sang Kyun Lee, Gwangmyung-si (KR); Jong Hoon Chung, Goonpo-si (KR)

Correspondence Address: LEE, HONG, DEGERMAN, KANG & SCHMADEKA, 14th Floor, 801 S. Figueroa Street, Los Angeles, CA, 90017, US

(73) Assignee: LG Electronics Inc.

(21) Appl. No.: 11/109,232

(22) Filed: Apr. 18, 2005

(30) Foreign Application Priority Data
Apr. 19, 2004 (KR) 10-2004-0026792

(51) Int. Cl. H04Q 7/20

(52) U.S. Cl. 455/433

(57) ABSTRACT

The present invention relates to a method of assigning and setting a home code to devices in a home network system such that the network system should be private from neighboring home networks and a home network system therefore. Upon a user's request of a home code, a network manager in accordance with the present invention determines whether the request is due to the initial set-up of a home network or to connection of a new device to the home network. In case of the initial set-up of a home network, the network manager creates a home code, determines if the created home code is being used in neighboring networks, and broadcasts the home code to all devices connected to the home network if it is determined that the home code is usable.

### BACKGROUND OF THE INVENTION

1. Field of the Invention

The present invention relates to a method of assigning and setting a unique network code to devices in a home network system such that the network system should be private from neighboring home networks by prohibiting devices in the network system from being accessed from other devices in outside network systems, and a home network system therefor.

2. Description of the Related Art

A home network system, which has attracted attentions recently in the information technology industry, enables to connect a home server to electronic appliances and to communicate with each other so that a particular device can be monitored and controlled through the home network.

Instead of LAN line, power lines can be used as a physical communication channel for a home network. If power line communication is used as network communication means, as shown in FIG. 1, a home network can be easily established with no additional cost for cabling because a plurality of electronic appliances 20a, 20b, 21a, 21b are able to exchange data between them via their existing power supply cables.

The power lines interconnecting the plurality of electronic appliances are, however, interconnected to neighboring houses or buildings. Hence, data exchanged between appliances in a home network established within a particular house or building may be transmitted to neighboring home networks through the power lines.

To be specific, FIG. 1 illustrates three distinct home networks G1, G2, G3. Electronic appliances, i.e., 20a and 20b in the network G1, 21a in the network G2, and 22a in the network G3 are interconnected through a common power line PL. Consequently, control commands from one home server 10, 11, or 12 in each home network are transmitted to electronic appliances belonging to neighboring home networks.

To solve the problem, a network administrator of each home network makes the home network virtually private from neighboring home networks by assigning and setting a home code to devices connected to the home network. By using a home code, it is possible to enable communication between devices having the same home code. It is because devices with different home codes are not able to communicate with each other.

A conventional method of assigning and setting a home code in a home network is as follows. When an electronic appliance is connected to the home network initially, a user requests a home server to assign a home code to the appliance newly connected and then the home server sends a home code to the appliance newly connected. In case that a home network is set up initially, a user requests the home server to set a home code for the set-up of the home network. In response to the request, the home server creates a home code and then broadcasts the home code to all of electronic appliances connected to the home network.

In the conventional method, when a user requests a home server to get a home code, the user should inform the home server of whether the request is due to the initial establishment of a home network or to connection of a new appliance to an established home network. This is inconvenient and even may be even troublesome because of wrong requests. For example, if a user adds a new appliance to an existing home network and wrongly requests a home code for the home network set-up, a home server may ignore the request because a home code has been set already therein, thereby not guaranteeing a normal operation of the home network.

### SUMMARY OF THE INVENTION

In view of the shortcomings of the prior art, it is an object of the present invention to provide a method of automatically determining whether a network code request is made due to the initial set-up of a home network or to connection of devices to an established home network and assigning a unique network code to either a particular device or all devices, and a home network system for implementing the method.

In the method according to the present invention, if a network code request message is received, it is determined whether the request is made due to the initial set-up of a home network or to connection of devices to an established home network. Depending on the determination result, a network code is created and set into all of devices connected to the home network. Or a home network code that has been used already may be sent and set into a device that is newly connected to the network.

In one embodiment of the present invention, if a network code set request is made to set up a home network for the first time, a network code is created and it is examined whether or not the created network code is being used in other home networks. If it is determined that the created network code is usable uniquely, it is broadcast to the home network so that the created network code is set into all devices connected to the home network.

In another embodiment, if there is no response to a message that is broadcast to the home network, then the network code set request is classified as a request for the home network set-up. Otherwise, it is determined that the network code set request was made to set a network code into a device newly connected to the home network.

In still embodiment, if there is any response to a message that is broadcast to the home network after a network code is created, then it is determined that the network code is being used in other networks. Otherwise, the network code is regarded as uniquely available one.

In yet another embodiment, if it is determined that the created network code is being used in other networks, the created network code is deleted and a new network code is recreated until a network code that is usable uniquely is found.

In a further embodiment, if it is determined that the network code set request is made to assign a network code to a device newly connected, a network code that has been used already is broadcast to the home network so that the network code is set into the device newly connected.

### BRIEF DESCRIPTION OF THE DRAWINGS

The above features and other advantages of the present invention will be more clearly understood from the following detailed description taken in conjunction with the accompanying drawings, in which:

FIG. 1 illustrates configuration of a home network system based on power line communication;

FIG. 2 illustrates configuration of a home network system embodying the present invention; and

FIG. 3 is a flowchart of the method of assigning and setting a home code in a home network system according to the present invention.

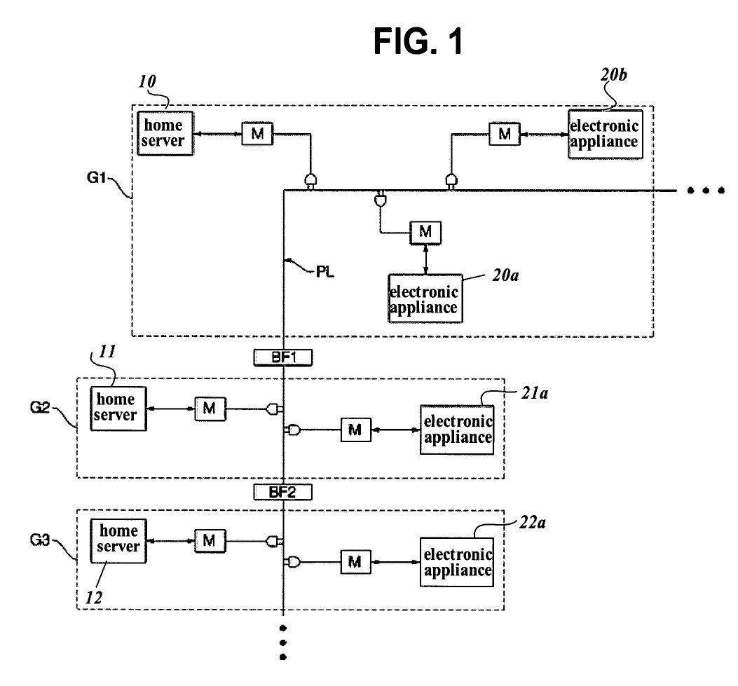

### DETAILED DESCRIPTION OF THE PREFERRED EMBODIMENTS

In order that the invention may be fully understood, preferred embodiments thereof will now be described with reference to the accompanying drawings.

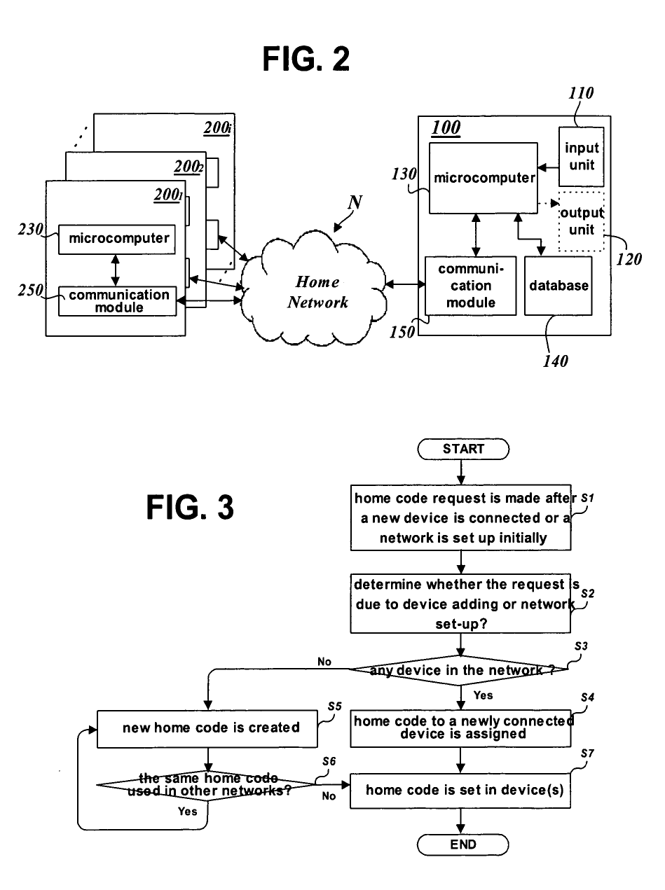

FIG. 2 illustrates a home network system wherein the present invention may be advantageously embodied. In such a home network N to which a plurality of electronic devices 200_{I} are connected, a network manager 100 controls communication between electronic devices 200_{I} and assigns a home code to each of the plurality of electronic devices.

In case that a home server (not shown in FIG. 2) is connected to the network N, the network manager 100 may be embedded in the home server.

A home code that is 4 bytes in length may be assigned uniquely to a home and if there is a plurality of home servers in a home, the plurality of electronic devices may be grouped by the plurality of home servers and a distinct home code may be uniquely assigned to each group. In this case, a plurality of virtual sub-networks is configured in a home.

The network manager 100 comprises a microcomputer 130 that assigns a home code to electronic devices belonging to the same group (the group sharing the same home code) and sends commands to the electronic devices so as to monitor their states and control their operations; a database 140 that stores information about the electronic devices, e.g., general information, control state information, and network (or sub network) information; an input unit that receives user's inputs and sends them to the microcomputer 130; and a communication unit 150 that generates and broadcasts a home code and communicating with the electronic devices.

The network manager 100 may further include a display unit 120 that displays network status information and the result of control commands in response to a control signal of the microcomputer 130. An easy-to-use user interface may be offered by implementing the display unit 130 as a touch panel embedded in the input unit 110.

In case that the network N is established on power lines, the communication unit 150 is a power line modem. In case of a wireless network, the communication unit 150 is implemented as a radio-frequency (RF) modem.

Each electronic device generally comprises a communication module 250 that receives control commands from the home server or the network manager 100, sends the control results, and performs operations of setting/clearing a home code; and a microcomputer 230 that executes operations of reading signals, sending control results to the home server or network manager 100, and setting/clearing a home code that is assigned by the network manager 100 into the communication module 250 according to control commands transmitted from the home server or network manager 100.

Likewise, the communication module 250 is implemented as a power line modem if the network N is configured on power lines. In case of a wireless network, the communication module 250 is implemented as a RF modem.

After an electronic device 200_{N} is initially connected to the network N or the initial configuration of a home network is completed, a network administrator sends a home code request message to the network manager 100. On receiving the request, the microcomputer 130 determines whether the request is for the initial set-up of a home code or for the connection of a device to the home network. The determination procedure is described below in detail.

First, the microcomputer 130 broadcasts a message to the home network N. The message should be one of messages that request responses from electronic devices in the home network N. An example is a device name request message. If a home code has been set in the communication unit 150 (It may be that a home code is not set yet), the home code is included in a head of the broadcast message. In this case, if there is a response to the broadcast message, which implies that the same home code has been set in the electronic devices, it is determined that the home code request was made due to connection of a new device to the home network. If there is no response, it is determined that the home code request was made for the initial set-up of a home network.

In case of the initial home network establishment, the network manager 100 executes operations to create a new home code and to set the home code into each of the plurality of electronic devices 200_{I}. To accomplish this, the microcomputer 130 sends a command to make the communication unit 150 generate a home code, and broadcast a message, e.g., a device mane request message to the home network N so as to receive responses from the plurality of electronic devices. The home code is created in the communication unit 150 by using a random number generation algorithm. The message is broadcast, with the home code included in its message header. If there is a response, which means that the home code is being used in other home networks, the network manager 100 performs operations for home code regeneration.

As mentioned before, signals within a home network could be transmitted to other home networks via a common network line such as power-line or a wireless communication network. Therefore, if there exists a home network having the same home code, undesirable data transmission between electronic devices in different home networks may destroy security and privacy protection. Hence, after generation of a home code, the network manager 100 determines if there exists a home network whose home code is the same as the regenerated home code by broadcasting a message to all electronic devices to the network, receiving and examining the responses from them. For example, the recipient address of the message is set to 0×FFFF to identify the message from others. If it is determined that a home network is using the same home code, a command is sent to the communication unit 150 where a home code is generated newly. The procedure above is repeated to determine if a home code is being used in other networks. If it is determined that the home code is not being used in other networks, a message is broadcast to the network N to make the plurality of electronic devices 200_{I} set the home code to their own communication modules 250.

On the other hand, if it is determined that a new device 200_{N} is connected to the network N initially, the network manager 100 broadcasts a message to the network N to make the device 200_{N} receive a home code that has been stored in the communication unit 150. On receiving the message, each of the plurality of devices sends a home code set command to its own communication module, but the device 200_{N} only sets the received home code to its communication module 250. It is because all the communication modules are configured such that a home code set command is ignored if a home code has been set already therein.

After setting a home code to each of the plurality of devices is completed as described above, a communication module 250 in each of the plurality of devices receives a message whose header includes the same home code as its own home code and transfers the message to its microcomputer 250. Consequently, it is possible that data exchange between devices belonging to different home networks are prevented due to sharing a communication channel.

FIG. 3 is a flowchart illustrating the method of setting a home code in a home network in accordance with the present invention.

If a home code setting is requested by a user after a home network is established initially or a new device is connected to a home network (S1), the network manager determines if the request is due to the initial network set-up or connection of a new device (S2). If there is any response to a broadcast message from one or more devices in the network (S3), which implies connection of a new device to the network, a home code that has been stored in the network manager is sent and set to the device newly connected by broadcasting a home code set message to the network (S4). If no response, a home code is created to set up the home network initially established (S5).

And then, it is determined whether or not the created home code is being used in other home networks or sub-networks by broadcasting a message and examining responses to the message. If other networks are using the home code (S6), the home code is deleted and the step of creating a home code is executed again. Once a non-duplicate home code is created, a home code set message is broadcast to set the home code into all of the devices connected to the network.

Receiving the home code set message, each device sets the home code in its own communication module by sending a home code set command (S7). At this time, the communication module in which a home code has been stored already ignores a home code set command.

In this way, in response to a home code set request, the network manager determines automatically whether the request is due to the initial network establishment or connection of a new device. Depending on the determination result, the network manager assigns an already-used home code to the device that connected newly to the network or creates a new home code and assigns the created home code to all of devices connected to the network.

The method of assigning a unique home code in a home network according to the present invention enables a home network administrator to request a home code irrespective of whether the home code is required by initial home network establishment or connection of a new device, thereby making network administration easier and less error-prone.

While the invention has been disclosed with respect to a limited number of embodiments, those skilled in the art, having the benefit of this disclosure, will appreciate numerous modifications and variations therefrom. It is intended that all such modifications and variations fall within the spirit and scope of the invention.

1. A method of assigning a network code to devices connected to a network, conducted by a network manager, comprising:
(a) upon a request of a network code, determining whether the network code request is made to set up a network initially or to add a device to a network; and
(b) if it is determined that the request is for the initial network set-up, creating a network code, determining whether or not the created network code is being used in other networks, and assigning the created network code to devices connected to the network, if the created network code is not being used in other networks.

2. The method as set forth in claim 1, wherein in the step (a), a message that requests a response is broadcast to the network, and if there is no response to the message, it is determined that the network code request was made to initially set up the network, and if there is a response to the message, it is determined that the network code request was made to add a device to the network.

3. The method as set forth in claim 1, wherein in the step (b), after a network code is created, a message that requests a response is broadcast to the network, and if there is a response to the message, it is determined that the created network code is being used in other networks, and if there is no response to the message, it is determined that the created network code is not being used in other networks.

4. The method as set forth in claim 3, wherein said other networks are networks that are connected to and data exchangeable with the network via wired or wireless communication means.

5. The method as set forth in claim 3, wherein in the step (b), if it is determined that the created network code is being used in other networks, the created network code is deleted, and a series of operations of creating a network code, confirming if there is any duplicate network code in other networks, and deleting a duplicate network code is performed until a non-duplicate network code is found.

6. The method as set forth in claim 1, wherein in the step (b), if it is determined that the network code request is for adding of a device to the network, a network code that has been created and used already is provided to the network so that the network code is set in the device newly connected.

7. A network system to which at least one device is connected, comprising:
a device whose states can be monitored and whose operations are controllable through the network; and
a network manager that, upon a request of a network code, determines whether the network code request is made to set up a network initially or to add a device to the network, creates a network code if it is determined that the request is for the initial network set-up, determines whether or not the created network code is being used in other networks, and assigns the created network code to the devices connected to the network if it is determined that the created network code is not being used in other networks.

8. The network system as set forth in claim 7, wherein the network manager comprising:
a communication module that creates a network code and communicates to the network; and
a control module that determines whether a network code request is made to set up a network initially or to add a device to the network, and if it is determined that the request is for the initial network set-up, sends a command to the communication module to create a network code, determines whether or not the created network code is being used in other networks, and broadcasts the created network code to the network via the communication module if the created network code is not being used in other networks.

9. The network system as set forth in claim 8, wherein the created network code is included in a header of the message that is broadcast to the network by the communication module.

10. The network system as set forth in claim 7, wherein the network manager broadcasts a message that requests a response to the network, and if there is no response to the message, determines that the network code request was made to initially set up the network, and determines that the network code request was made to add a device to the network, if there is a response to the message.

11. The network system as set forth in claim 7, wherein after creating a network code, the network manager broadcasts a message that requests a response to the network, and if there is a response to the message, determines that the created network code is being used in other networks, and determines that the created network code is not being used in other networks, if there is no response to the message.

12. The network system as set forth in claim 11, wherein said other networks are networks that are connected to and data exchangeable with the network via wired or wireless communication means.

13. The network system as set forth in claim 11, wherein if it is determined that the created network code is being used in other networks, the network manager deletes the created network code and performs a series of operations of creating a network code, confirming if there is any duplicate network code in other networks, and deleting a duplicate network code is performed, until a non-duplicate network code is found.

14. The network system as set forth in claim 7, wherein if it is determined that the network code request is for adding of a device to the network, the network manager provides a network code that has been created and used already to the network so that the network code is set in the device newly connected.

15. The network system as set forth in claim 14, wherein the network code that has been created already is stored in a communication module that communicates to the network.

16. The network system as set forth in claim 7, wherein the device receives a network code via the network and sets the network code into a communication module therein.
